(19) United States
(12) Patent Application Publication
(10) Pub. No.: US 2008/0210541 A1
(43) Pub. Date: Sep. 4, 2008

(54) Distillation Process

(75) Inventors: Kevin S. Wenger, Wake Forest, NC (US); Eric Allain, Wake Forest, NC (US); Stephen M. Lewis, Siouz Falls, SD (US); John Michael Finck, Tripp, SD (US); Debbie Lynn Roth, Olivet, SD (US)

Correspondence Address: NOVOZYMES NORTH AMERICA, INC., 500 FIFTH AVENUE, SUITE 1600, NEW YORK, NY, 10110, US

(73) Assignees: Novozymes North America, Inc., Franklinton, NC (US); Broin and Associates, Inc., Siouz Falls, SD (US)

(21) Appl. No.: 11/547,502

(22) PCT Filed: Apr. 6, 2005
(86) PCT No.: PCT/US05/11428

§ 371 Date: Jul. 11, 2007

Related U.S. Application Data
(60) Provisional application No. 60/560,099, filed on Apr. 6, 2004.

(51) Int. Cl. B01D 3/34

(52) U.S. Cl. 203/57

(57) ABSTRACT

The present invention relates to an improved process of distilling fermented mash, wherein one or more amylases and/or proteases are added to the fermentation mash before or during distillation.

### FIELD OF THE INVENTION

The present invention relates to improved processes of distilling fermented mash and processes for producing a liquid fermentation product including an improved distillation process of the invention.

### BACKGROUND OF THE INVENTION

When producing liquid fermentation products, such as ethanol, the desired liquid product is often separate from a fermentation mash by distillation. Basically, distillation comprises the steps of volatilizing or evaporating the fermentation mash and subsequently condensing the volatized or vaporized material to provide a liquid product comprising a higher content of the desired liquid fermentation product. If desired said liquid product may be distilled again or purified using other means. For instance, industrial ethanol distillation is generally produced at a strength of 96% by volume ethanol (192° US proof). Modern distillation systems used for ethanol distillation are in general multi-stage, continuous, counter current, vapour-liquid contacting systems that operate based on the fact that materials boil at different temperatures.

There is a need for further improvement of distillation processes, in particular for ethanol production.

### BRIEF DESCRIPTION OF THE DRAWING

FIG. 1: Kinetics of glucose utilization illustrates higher initial glucose arising from distillation based dextrinization.

### DETAILED DESCRIPTION OF THE INVENTION

The present invention relates to an improved process of distilling fermented mash to provide a desired liquid fermentation product and a process of producing a liquid fermentation product, especially ethanol, comprising an improved distillation process of the invention.

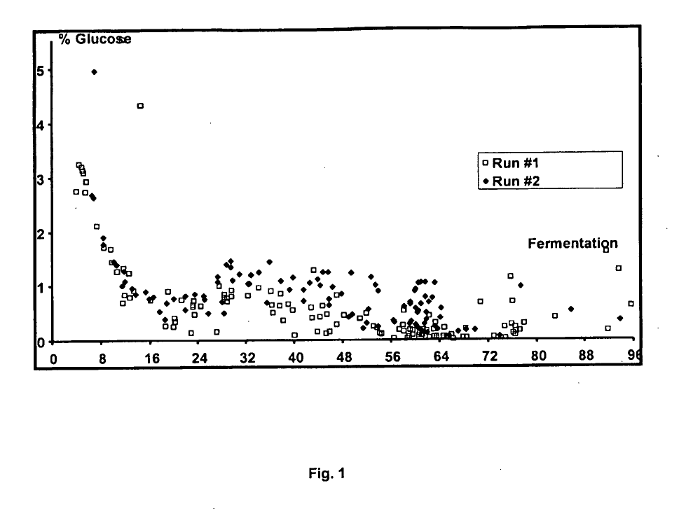

The inventors have found that addition of one or more amylases and/or proteases to fermented mash before or during distillation reduce accumulation or build-up of solid carbohydrate and/or proteinaceous material on the inner surface of the distillation equipment and thus reduce fouling caused by said solid carbohydrate and/or proteinaceous material. Reduced fouling increases the amount of residual sugars that may be recovered from the “stillage”, i.e., the fraction left behind after distillation of the fermented mash, eases cleaning of the distillation equipment and thus reduces the cost of distillation and/or extends the period that the distillation equipment can be used without cleaning. The above mentioned increased amount of residual sugars may advantageously be recycled to the fermentation tank, e.g., by recycling the thin stillage, i.e., liquid fraction of Stillage after distillation. In Example 1 the effect of alpha-amylase and protease addition prior to distillation is tested. The consistently higher glucose after distillation indicates that alpha-amylase (and protease) addition prior to distillation has the potential to dextrinize residual starches as is indicated by the increased level of glucose in FIG. 1. It is believed the higher temperature in the distillation column is an embodiment of this invention. The results in Example 1 suggest that alpha-amylase (and protease enzyme) acted synergistically to decrease viscosity in the distillation process. The results also suggest that alpha-amylase (and protease enzyme) added prior to distillation increased the amount of glucose production during distillation which can be routed to the fermentation tank for further fermenting.

In the first aspect the invention relates to a process of distilling fermented mash by adding one or more amylases and/or proteases to the fermented mash before distillation or during distillation. The amylase(s) and/or protease(s) may in one embodiment be introduced/added to the feed stream of fermented mash coming from the fermentation equipment before entering the distillation equipment, such as a first and/or subsequent distillation column(s). However, it is also within the scope of the present invention to introduce the amylase(s) and/or protease(s) directly into the distillation equipment, such as the first and/or subsequent distillation column(s). In embodiments of the invention the alpha-amylase and/or protease are added at the beginning and/or end of fermentation fill. In other embodiments the alpha-amylase and/or protease are added in the beer well or another locations before distillation.

### Fermented Mash

In context of the present invention the term “fermented mash” means any plant (starting) material, preferably liquefied and/or saccharified starch-containing plant material, having been subjected to one or more fermenting organisms under suitable conditions. In a preferred embodiment the fermented mash is prepared from dry or wet milled starch-containing plant material(s). In a preferred embodiment the fermented mash is plant material(s), such as tubers, roots, whole grains, including corns, cobs, wheat, barley, rye, milo and cereals, sugar-containing raw materials, such as molasses, fruit materials, sugar, cane or sugar beet, potatoes, which has(have) been fermented using one or more fermenting organisms under suitable conditions. In a preferred embodiment the fermented mash is whole grains, especially corn, fermented by subjecting liquefied and/or saccharified whole grains to yeast under conditions suitable for fermentation. Preferred yeasts are of the genus Saccharomyces, especially S. cerevisae.

### Fermenting Organism

The term “Fermenting organism” refers to any organism known to be capable of fermenting sugars or converted sugars, such as glucose or maltose, directly or indirectly into the desired liquid fermentation product. Examples of contemplated organisms include fungal organisms, such as yeasts and filamentous fungi. Examples of specific filamentous fungi include strains of Penicillium sp. The preferred fermenting organism for ethanol production is yeast. Preferred yeast is baker's yeast, also known as Saccharomyces cerevisiae. Commercially available yeast includes, without being limited thereto, RED STAR®/Lesaffre Ethanol Red (available from Red Star/Lesaffre, USA) FALI (available from Fleischmann's Yeast, USA), SUPERSTART (available from Alltech), GERT STRAND (available from Gert Strand AB, Sweden) and FERMIOL (available from DSM Specialties). The yeast is usually added before starting the actual fermentation (i.e., during the propagation phase). The yeast cells may be added in amounts of 10⁵ to 10¹², preferably from 10⁷ to 10¹⁰, especially 5×10⁷ viable yeast counts per ml of fermentation broth. During the ethanol producing phase the yeast cell count should preferably be in the range from 10⁷ to 10¹⁰, especially around 2×10⁸. Further guidance in respect of using yeast for fermentation can be found in, e.g., “The alcohol Textbook” (Editors K. Jacques, T. P. Lyons and D. R. Kelsall, Nottingham University Press, United Kingdom 1999), which is hereby incorporated by reference.

### The Liquid Fermentation Product

The liquid fermentation product may be any liquid fermentation product. Preferred products are alcohols, especially ethanol, e.g., fuel or potable ethanol. Also contemplated are beverages, such as beer or wine, but also other beverages are contemplated.

### Distillation

The term “distillation” is used in context of the present invention in its tradition sense, i.e., a process in which a mixture of two or more substances is separated into its component fractions of desired purity, by the application and removal of heat. For instance, ethanol is removed from the fermented mash by taking advantage of its boiling point. The ethanol distillation temperature is in the range between 60-100° C., preferably 70-90° C., especially around the boiling point of ethanol which is 78.3° C. The water and solids left behind after ethanol distillation are often referred to as “stillage”.

### Amylase

According to the processes of the invention the amylase may be any amylase, preferably an alpha-amylase, especially of fungal or bacterial origin. In one embodiment the alpha-amylase is a Bacillus alpha-amylase, such as an alpha-amylase derived from a strain of Bacillus licheniformis, Bacillus amyloliquefaciens, Bacillus subtilis or Bacillus stearothermophilus. Other alpha-amylases include alpha-amylases derived from a strain of the Bacillus sp. NCIB 12289, NCIB 12512, NCIB 12513 or DSM 9375, all of which are described in detail in WO 95/26397, and the alpha-amylase described by Tsukamoto et al., Biochemical and Biophysical Research Communications, 151 (1988), pp. 25-31. The alpha-amylase may also be a variant or a hybrid. Alpha-amylase variants and hybrids are described in, e.g., WO 96/23874, WO 97/41213, and WO 99/19467. Other alpha-amylase includes alpha-amylases derived from a strain of Aspergillus, such as, Aspergillus oryzae and Aspergillus niger. In one embodiment the alpha-amylase is an acid alpha-amylase. In another embodiment the acid alpha-amylase is an acid fungal alpha-amylase or an acid bacterial alpha-amylase. The acid alpha-amylase may be an acid fungal alpha-amylase derived from the genus Aspergillus. A commercially available acid fungal amylase is SP288 (available from Novozymes A/S, Denmark). The term “acid alpha-amylase” means an alpha-amylase (E.C. 3.2.1.1) which when used in an effective amount has activity at a pH in the range of 3.0 to 7.0, preferably from 3.5 to 6.0, or more preferably from 4.0-5.0. Also contemplated are acid fungal alpha-amylases referred to as FUNGAMYL™-like alpha-amylase. In the present disclosure, the term “FUNGAMYL-like alpha-amylase” covers alpha-amylases which exhibits a high identity, i.e., more than 50%, preferably at least 55%, more preferably 60%, even more preferably at least 65%, more preferably at least 70%, more preferably at least 75%, more preferably at least 80%, more preferably at least 85%, more preferably at least 90%, more preferably at least 95%, even more preferably 97% identity to the amino acid sequence shown in SEQ ID No: 10 in WO 96/23874. Preferably the alpha-amylase is an acid alpha-amylase, preferably from the genus Aspergillus, preferably of the species Aspergillus niger or Aspergillus oryzae. In a preferred embodiment the acid fungal alpha-amylase is the A. niger acid alpha-amylase disclosed as “AMYA_ASPNG” in the Swiss-prot/eEMBL database under the primary accession no. P56271. Also contemplated are variants of said acid fungal amylase having at least 70% identity, such as at least 80%, even more preferred at least 90%, even more preferred at least 95%, even more preferred at least 97% identity thereto.

Preferred commercial compositions comprising alpha-amylase include MYCOLASE™ from DSM (Gist Brochades), BAN™, TERMAMYL™ SC, LIQUOZYME™ SC, FUNGAMYL™, LIQUOZYME™ X (Novozymes A/S) and CLARASE™ L-40,000, DEX-LO™, SPEYME™ FRED, SPEZYME™ FRED-L, SPEZYME™ AA, SPEZYME™ ETHYL and SPEZYME™ DELTA AA, GC262, G-ZYME G997, G-ZYME G995, (Genencor Int., USA), SKA 2000 (Biosinteze), Alpha-Amylase from ENMEX, and the acid fungal alpha-amylase sold under the tradename SP 288 (available from Novozymes A/S, Denmark). The amylase may also be a maltogenic alpha-amylase. A “maltogenic alpha-amylase” (glucan 1,4-alpha-maltohydrolase, E.C. 3.2.1.133) is able to hydrolyze amylose and amylopectin to maltose in the alpha-configuration. A maltogenic alpha-amylase from B. stearothermophilus strain NCIB 11837 is commercially available from Novozymes A/S under the tradename NOVAMYL™. Maltogenic alpha-amylases are described in U.S. Pat. Nos. 4,598,048, 4,604,355 and 6,162,628, which are hereby incorporated by reference. Preferably, the maltogenic alpha-amylase is used in a raw starch hydrolysis process, as described, e.g., in WO 95/10627, which is hereby incorporated by reference.

The alpha-amylase may in accordance with the present invention be added in an amount so that the concentration in the fermentation mash, determined when entering the distillation equipment, is in the range from 0.01-1.0 AFAU per liter fermented mash, preferably 0.02 to 0.2 AFAU per liter fermented mash. If the fermented mash is prepared by SSF the alpha-amylase concentration is preferably in the range from 0.02 to 0.5 AFAU per liter fermented mash, while the preferred concentration is in the range from 0.2 to 1.0 AFAU per liter fermented mash if the fermented mash is from an LSF process (i.e, simultaneous liquefaction, saccharification and fermentation process or one step fermentation process).

### Protease

According to the present invention the protease used may be any protease. Proteases are well known in the art and refer to enzymes that catalyze the cleavage of peptide bonds. Suitable proteases include fungal and bacterial proteases. Preferred proteases are acid proteases, i.e., proteases characterized by the ability to hydrolyze proteins under acidic conditions, e.g., below pH 7. Suitable acid fungal proteases include fungal proteases derived from Aspergillus, Mucor, Rhizopus, Candida, Coriolus, Endothia, Enthomophtra, Irpex, Penicillium, Sclerotium and Torulopsis. In a preferred embodiment the protease is derived from a strain of Aspergillus, prefereably Aspergillus niger (see, e.g., Koaze et al., (1964), Agr. Biol. Chem. Japan, 28, 216), Aspergillus saitoi (see, e.g., Yoshida, (1954) J. Agr. Chem. Soc. Japan, 28, 66), Aspergillus awamori (Hayashida et al., (1977) Agric. Biol. Chem., 42(5), 927-933, Aspergillus aculeatus (WO 95/02044), or Aspergillus oryzae; and acid proteases from Mucor pusillus or Mucor miehei.

Contemplated bacterial proteases, which are not acidic proteases, include the commercially available products ALCALASE™ and NEUTRASE™ (available from Novozymes A/S). Other proteases include GC106 from Genencor Int, Inc., USA and NOVOZYM™ 5006 from Novozymes A/S, Denmark.

Preferably, the protease is an aspartic acid protease, as described, for example, Handbook of Proteolytic Enzymes, Edited by A. J. Barrett, N. D. Rawlings and J. F. Woessner, Academic Press, San Diego, 1998, Chapter 270). Suitable examples of aspartic acid protease include, e.g., those disclosed in R. M. Berka et al. Gene, 96, 313 (1990)); (R. M. Berka et al. Gene, 125, 195-198 (1993)); and Gomi et al. Biosci. Biotech. Biochem. 57, 1095-1100 (1993), which are hereby incorporated by reference.

The protease may in accordance with the present invention be added in an amount so that the concentration in the fermentation mash, determined when entering the distillation equipment, is in the range from 0.01-1 SAPU per liter fermented mash, preferably 0.02 to 0.2 SAPU per liter mash.

### Glucoamylase

The glucoamylase(s) used according the invention may be derived from any suitable source, e.g., derived from a micro-organism or a plant. Preferred glucoamylases are of fungal or bacterial origin, selected from the group consisting of Aspergillus glucoamylases, in particular A. niger G1 or G2 glucoamylase (Boel et al. (1984), EMBO J. 3 (5), p. 1097-1102), or variants thereof, such as disclosed in WO 92/00381 and WO 00/04136; the A. awamori glucoamylase (WO 84/02921), A. oryzae (Agric. Biol. Chem. (1991), 55 (4), p. 941-949), or variants or fragments thereof.

Other Aspergillus glucoamylase variants include variants to enhance the thermal stability: G137A and G139A (Chen et al. (1996), Prot. Engng. 9, 499-505); D257E and D293E/Q (Chen et al. (1995), Prot. Engng. 8, 575-582); N182 (Chen et al. (1994), Biochem. J. 301, 275-281); disulphide bonds, A246C (Fierobe et al. (1996), Biochemistry, 35, 8698-8704; and introduction of Pro residues in position A435 and S436 (Li et al. (1997), Protein Engng. 10, 1199-1204. Other glucoamylases include Athelia rolfsii glucoamylase (U.S. Pat. No. 4,727,046), Talaromyces glucoamylases, in particular, derived from Talaromyces emersonii (WO 99/28448), Talaromyces leycettanus (U.S. Pat. No. Re. 32,153), Talaromyces duponti, Talaromyces thermophilus (U.S. Pat. No. 4,587,215). Bacterial glucoamylases contemplated include glucoamylases from the genus Clostridium, in particular C. thermoamylolyticum (EP 135,138), and C. thermohydrosulfuricum (WO 86/01831).

Commercially available compositions comprising glucoamylase include AMG 200L; AMG 300 L; SAN™ SUPER, SAN™ EXTRA L, SPIRIZYME™ PLUS, SPIRIZYME™ FUEL, SPIRIZYME™ B4U and AMG™ E (from Novozymes A/S); OPTIDEX™ 300 (from Genencor Int.); AMIGASE™ and AMIGASE™ PLUS (from DSM); G-ZYME™ G900, G-ZYME™ and G990 ZR (from Genencor Int.).

Glucoamylases may in an embodiment be added in an amount of 0.02-20 AGU/g DS, preferably 0.1-10 AGU/g DS, such as 2 AGU/g DS.

### Ethanol Production

In one aspect the invention relates to an ethanol production process. Any starch-containing starting plant material including the plant materials mentioned above may be used in accordance with an ethanol process of the invention. However, the preferred starting material is whole grains. In one embodiment a process of the invention include recovering residual sugars from the stillage including the thin stillage fraction. In a further embodiment a process of the invention the thin stillage is recycled to the fermentor.

According to this aspect of the invention the process of producing a fermentation product, preferably ethanol, comprises the following steps:
(a) milling plant material,
(b) liquefaction of milled plant material by acid treatment or treatment with an amylase
(c) saccharifying the liquefied milled material with an enzyme composition comprising a glucoamylase,
(d) fermenting using a fermenting organism, and
(e) distilling the fermented mash obtained in step (d) in accordance with the distillation process of the invention.

Specific embodiments of the steps comprised in a process of the invention are outlined below. However, it is to be understood that the steps can also be carried out in a different manner.

### Milling

The plant (starting) material, such as whole grains, is milled (or reduced in size in another way) in order to open up the structure and allowing for further processing. Two processes are preferred according to the invention: wet and dry milling. Preferred for ethanol production is dry milling where the whole grain kernels are milled and used in the remaining part of the process. Wet milling may also be used and gives a good separation of germ and meal (starch granules and protein) and is with a few exceptions applied at locations where there is a parallel production of syrups. Both dry and wet milling is well known in the art of, e.g., ethanol production and contemplated according to the present invention.

### Liquefaction or Saccharification

The liquefaction and/or saccharification steps may be carried out simultaneously with or separately from the fermentation step. In an embodiment of the present invention, the saccharification and fermentation step are carried out simultaneously (often refer to as SSF process). In another embodiment the liquefaction, saccharification and fermentation steps are carried out simultaneously (often referred to as “LSF” process or one step fermentation process).

“Liquefaction” is a process in which milled (whole) grain raw material is broken down (hydrolyzed) into maltodextrins (dextrins). Liquefaction may be carried out as a three-step hot slurry process. The slurry is heated to between 60-95° C., preferably 80-85° C., and the enzymes are added to initiate liquefaction (thinning). The slurry may then be jet-cooked at a temperature between 95-140° C., preferably 105-125° C. to complete gelatinization of the slurry. The jet-cooking step may in one embodiment be left out. Then the slurry is cooled to 60-95° C. and more enzyme(s) may be added to finalize hydrolysis (secondary liquefaction). The liquefaction process is usually carried out at pH 4.5-6.5, in particular at a pH between 5 and 6. Milled and liquefied whole grains are known as mash. The liquefaction processes are typically carried out using any of the alpha-amylases listed above in the “Amylase” section. Other enzyme activities may also be added.

“Saccharification” is a process in which maltodextrins (such as the product from the liquefaction process) is converted to low molecular sugars DP₁₋₃ (i.e., carbohydrate source) that can be metabolized by the fermenting organism, such as, yeast. Saccharification processes are well known in the art and typically include the use of enzymes having glucoamylase activity. Alternatively or in addition, alpha-glucosidases or acid alpha-amylases may be used. A full saccharification process may last up to from about 24 to about 72 hours, and is often carried out at temperatures from about 30 to 65° C., and at a pH between 4 and 5, normally at about pH 4.5. However, it is often more preferred to do a pre-saccharification step, lasting for about 40 to 90 minutes, at a temperature between 30-65° C., typically about 60° C., followed by complete saccharification during fermentation in a simultaneous saccharification and fermentation process (SSF).

Which fermenting organism is suitable for the fermentation step depends on the desired fermentation product. In the case of alcohol production, in particular ethanol production, the fermenting organism may be a yeast, in particular derived from Saccharomyces spp., especially Saccharomyces cerevisiae, which is added to the mash and the fermentation is ongoing for 24-96 hours, such as typically 35-60 hours. The temperature is between 26-34° C., in particular about 32° C., and the pH is from pH 3-6, preferably around pH 4-5.

With respect to SSF and LSF processes the fermenting organism, such as the yeast, and the enzyme(s) may be added together or separately. In SSF processes, it is common to introduce a pre-saccharification step at a temperature above 50° C., just prior to the fermentation. During a simultaneous liquefaction-saccharification-fermentation (LSF) process the liquefaction, saccharification and fermentation are all carried out in one process step, that is, all enzymes (or substitutable or additional non-enzymatic agents) used for liquefaction, saccharification and fermentation are added in the same process step, more preferably, simultaneously in the same process step. Preferably optimal process conditions for the fermenting organism are used. For LSF processes this typically means temperatures of about 26° C. to 40° C., preferably about 30 to 37° C., especially about 32° C., pH of about 4 to about 8, preferably between 4.0 and 5.5, especially about pH 5, and process times of about 48 to 72 hours, preferably about 72 hours. In one embodiment the ethanol production process of the invention is carried out as a LSF process directly on raw starch. A “raw starch hydrolysis” process (RSH) differs from a conventional starch treatment process in that raw uncooked starch, also referred to as granular starch, is used in the ethanol fermentation process. As used herein, the term “granular starch” means raw uncooked starch, i.e., starch in its natural form found in cereal, tubers or grains. Starch is formed within plant cells as tiny granules insoluble in water. When put in cold water, the starch granules may absorb a small amount of the liquid and swell. At temperatures up to about 50° C. to 75° C. the swelling may be reversible. However, with higher temperatures (cooking) an irreversible swelling called gelatinization begins. In one embodiment the temperature is kept below the gelatinization temperature.

In a third aspect the invention relates to a process for the production of ethanol, comprising the steps of:
(a) milling plant material,
(b) saccharifying, without cooking, the milled material obtained in step (a) with an enzyme composition comprising acid fungal amylase,
(c) fermenting using a fermenting organism, and
(d) distilling the fermented mash obtained in step (c) in accordance with the distillation process of the invention.

Steps (b) and (c) may be carried out sequentially or simultaneously. Further, the milling step may be carried out using other well known technologies for reducing the particle size of the starch-containing plant material.

The milled plant material may be any wet or dry milled plant material as described above in the section “Fermented Mash”. The enzyme composition used in step (b) may further comprise a glucoamylase. The glucoamylase may be any glucoamylase. Preferred are the glucoamylases described below in the section “Glucoamylase”. Preferably glucoamylases are derived from a strain of Aspergillus, especially A. niger or A. oryzae, or Talaromyces, especially T. emersonii. The acid fungal amylase used in step (b) may be any acid fungal alpha-amylase. Preferred are acid fungal alpha-amylases derived from a strain of Aspergillus, especially Aspergillus niger or Aspergillus oryzae. In one embodiment the saccharification and fermentation is carried out simultaneously (SSF). It is preferred a pre-saccharification step is followed by fermentation and saccharification (SSF). The fermentation may be carried out using an organism capable of fermenting sugars to ethanol. Such organisms are described above in the section “Fermenting Organism”. The preferred fermenting organism is yeast; especially yeast derived from Saccharomyces spp., in particular Saccharomyces cerevisae.

In an embodiment the process of producing ethanol comprises the steps of:
(a) milling plant material,
(b) liquefying, saccharifying, and fermenting the milled plant material using a fermenting organism, and
(c) distillation of the fermented and saccharified material obtained in step (c) in accordance with the distillation process of the invention.
   In a preferred embodiment the LSF step (b) is carried out without cooking (un-gelatinized starch). Acid alpha-amylase and/or glucoamylase are present during LSF in step (b). Details on process conditions and enzymes can be found above.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and de-scribed herein will become apparent to those skilled in the art from the foregoing description. Such modifications are also intended to fall within the scope of the appended claims. In the case of conflict, the present disclosure including definitions will control.

Various references are cited herein, the disclosures of which are incorporated by reference in their entireties. The present invention is further described by the following examples which should not be construed as limiting the scope of the invention.

### Materials and Methods

### Determination of Acid Amylolytic Activity Error! Reference Source not Found. (FAU)

One Fungal Alpha-Amylase Unit (1 FAU) is defined as the amount of enzyme, which breaks down 5.26 g starch (Merck Amylum solubile Erg. B.6, Batch 9947275) per hour at Novozymes standard method for determination of alpha-amylase based upon the following standard conditions:

| | |
|---|---|
| Substrate | Soluble starch |
| Temperature | 37° C. |
| pH | 4.7 |
| Reaction time | 7-20 minutes |

A detailed description of Novozymes' method is available on request.

### Determination of Acid Alpha-Amylase Activity (AFAU)

Acid alpha-amylase activity is measured in AFAU (Acid Fungal Alpha-amylase Units), which are determined relative to an enzyme standard.

The standard used is AMG 300 L (wild type A. niger G1 AMG sold by Novozymes A/S, Denmark). The neutral alpha-amylase in this AMG falls after storage at room temperature for 3 weeks from approx. 1 FAU/mL to below 0.05 FAU/mL.

The acid alpha-amylase activity in this AMG standard is determined in accordance with AF 9 1/3 (available from Novo method for the determination of fungal alpha-amylase). In this method, 1 AFAU is defined as the amount of enzyme, which degrades 5.260 mg starch dry matter per hour under standard conditions.

Iodine forms a blue complex with starch but not with its degradation products. The intensity of colour is therefore directly proportional to the concentration of starch. Amylase activity is determined using reverse colorimetry as a reduction in the concentration of starch under specified analytic conditions.
Alpha-amylase

Starch+Iodine→Dextrins+Oligosaccharides
40° C., pH 2.5

Blue/violet t=23 sec. Decolouration

Standard conditions/reaction conditions: (per minute)

| | |
|---|---|
| Substrate: | starch, approx. 0.17 g/L |
| Buffer: | Citrate, approx. 0.03 M |
| Iodine (I₂): | 0.03 g/L |
| CaCl₂: | 1.85 mM |
| pH: | 2.50 ± 0.05 |
| Incubation temperature: | 40° C. |
| Reaction time: | 23 seconds |
| Wavelength: | Lambda = 590 nm |
| Enzyme concentration: | 0.025 AFAU/mL |
| Enzyme working range: | 0.01-0.04 AFAU/mL |

Further details can be found in EB-SM-0259.02/01 available on request from Novozymes, and hereby incorporated by reference.

### Glucoamylase Activity (AGI)

Glucoamylase (equivalent to amyloglucosidase) converts starch into glucose. The amount of glucose is determined here by the glucose oxidase method for the activity determination. The method described in the section 76-11 Starch-Glucoamylase Method with Subsequent Measurement of Glucose with Glucose Oxidase in “Approved methods of the American Association of Cereal Chemists”. Vol. 1-2 MCC, from American Association of Cereal Chemists, (2000); ISBN: 1-891127-12-8.

One glucoamylase unit (AGI) is the quantity of enzyme which will form 1 micromol of glucose per minute under the standard conditions of the method.

### Standard Conditions/Reaction Conditions:

| | |
|---|---|
| Substrate: | Soluble starch. |
| | Concentration approx. 16 g dry matter/L. |
| Buffer: | Acetate, approx. 0.04 M, pH = 4.3 |
| pH: | 4.3 |
| Incubation temperature: | 60° C. |
| Reaction time: | 15 minutes |
| Termination of the reaction: | NaOH to a concentration of approximately |
| | 0.2 g/L (pH~9) |
| Enzyme concentration: | 0.15-0.55 AAU/mL. |

The starch should be Lintner starch, which is a thin-boiling starch used in the laboratory as colorimetric indicator. Lintner starch is obtained by dilute hydrochloric acid treatment of native starch so that it retains the ability to color blue with iodine.

### Acid Alpha-Amylase Units (AAU)

The acid alpha-amylase activity can be measured in AAU (Acid Alpha-amylase Units), which is an absolute method. One Acid Amylase Unit (AAU) is the quantity of enzyme converting 1 g of starch (100% of dry matter) per hour under standardized conditions into a product having a transmission at 620 nm after reaction with an iodine solution of known strength equal to the one of a color reference.

Standard Conditions/Reaction Conditions:

| | |
|---|---|
| Substrate: | Soluble starch. Concentration approx. 20 g |
| | DS/L. |
| Buffer: | Citrate, approx. 0.13 M, pH = 4.2 |
| Iodine solution: | 40.176 g potassium iodide + 0.088 g iodine/L |
| City water | 15°-20°dH (German degree hardness) |
| pH: | 4.2 |
| Incubation temperature: | 30° C. |
| Reaction time: | 11 minutes |
| Wavelength: | 620 nm |
| Enzyme concentration: | 0.13-0.19 AAU/mL |
| Enzyme working range: | 0.13-0.19 AAU/mL |

The starch should be Lintner starch, which is a thin-boiling starch used in the laboratory as colorimetric indicator. Lintner starch is obtained by dilute hydrochloric acid treatment of native starch so that it retains the ability to color blue with iodine. Further details can be found in EP0140410B2, which disclosure is hereby included by reference.

### Determination of Alpha-Amylase Activity (KNU)

### 1. Phadebas Assay

Alpha-amylase activity is determined by a method employing PHADEBAS® tablets as substrate. Phadebas tablets (PHADEBAS® Amylase Test, supplied by Pharmacia Diagnostic) contain a cross-linked insoluble blue-colored starch polymer, which has been mixed with bovine serum albumin and a buffer substance and tabletted.

For every single measurement one tablet is suspended in a tube containing 5 ml 50 mM Britton-Robinson buffer (50 mM acetic acid, 50 mM phosphoric acid, 50 mM boric acid, 0.1 mM CaCl₂, pH adjusted to the value of interest with NaOH). The test is performed in a water bath at the temperature of interest. The alpha-amylase to be tested is diluted in x ml of 50 mM Britton-Robinson buffer. 1 ml of this alpha-amylase solution is added to the 5 ml 50 mM Britton-Robinson buffer. The starch is hydrolyzed by the alpha-amylase giving soluble blue fragments. The absorbance of the resulting blue solution, measured spectrophotometrically at 620 nm, is a function of the alpha-amylase activity.

It is important that the measured 620 nm absorbance after 10 or 15 minutes of incubation (testing time) is in the range of 0.2 to 2.0 absorbance units at 620 nm. In this absorbance range there is linearity between activity and absorbance (Lambert-Beer law). The dilution of the enzyme must therefore be adjusted to fit this criterion. Under a specified set of conditions (temperature, pH, reaction time, buffer conditions) 1 mg of a given alpha-amylase will hydrolyze a certain amount of substrate and a blue colour will be produced. The colour intensity is measured at 620 nm. The measured absorbance is directly proportional to the specific activity (activity/mg of pure alpha-amylase protein) of the alpha-amylase in question under the given set of conditions.

### 2. Alternative Method

Alpha-amylase activity is determined by a method employing the PNP-G7 substrate. PNP-G7 which is a abbreviation for p-nitrophenyl-alpha,D-maltoheptaoside is a blocked oligosaccharide which can be cleaved by an endo-amylase. Following the cleavage, the alpha-Glucosidase included in the kit digest the substrate to liberate a free PNP molecule which has a yellow colour and thus can be measured by visible spectophometry at λ=405 nm. (400-420 nm). Kits containing PNP-G7 substrate and alpha-Glucosidase is manufactured by Boehringer-Mannheim (cat. No. 1054635).

To prepare the substrate one bottle of substrate (BM 1442309) is added to 5 ml buffer (BM1442309). To prepare the alpha-Glucosidase one bottle of alpha-Glucosidase (BM 1462309) is added to 45 ml buffer (BM1442309). The working solution is made by mixing 5 ml alpha-Glucosidase solution with 0.5 ml substrate.

The assay is performed by transforming 20 micro I enzyme solution to a 96 well microtitre plate and incubating at 25° C. 200 micro I working solution, 25° C. is added. The solution is mixed and pre-incubated 1 minute and absorption is measured every 15 sec. over 3 minutes at OD 405 nm.

The slope of the time dependent absorption-curve is directly proportional to the specific activity (activity per mg enzyme) of the alpha-amylase in question under the given set of conditions.

### Glucoamylase Activity (AGU)

The Novo Glucoamylase Unit (AGU) is defined as the amount of enzyme, which hydrolyzes 1 micromole maltose per minute under the standard conditions 37° C., pH 4.3, substrate: maltose 23.2 mM, buffer: acetate 0.1 M, reaction time 5 minutes.

An autoanalyzer system may be used. Mutarotase is added to the glucose dehydrogenase reagent so that any alpha-D-glucose present is turned into beta-D-glucose. Glucose dehydrogenase reacts specifically with beta-D-glucose in the reaction mentioned above, forming NADH which is determined using a photometer at 340 nm as a measure of the original glucose concentration.

| AMG incubation: | |
|---|---|
| Substrate: | maltose 23.2 mM |
| Buffer: | acetate 0.1 M |
| pH: | 4.30 ± 0.05 |
| Incubation temperature: | 37° C. ± 1 |
| Reaction time: | 5 minutes |
| Enzyme working range: | 0.5-4.0 AGU/mL |

| Color reaction: | |
|---|---|
| GlucDH: | 430 U/L |
| Mutarotase: | 9 U/L |
| NAD: | 0.21 mM |
| Buffer: | phosphate 0.12 M; 0.15 M NaCl |
| pH: | 7.60 ± 0.05 |
| Incubation temperature: | 37° C. ± 1 |
| Reaction time: | 5 minutes |
| Wavelength: | 340 nm |

A folder (EB-SM-0131.02/01) describing this analytical method in more detail is available on request from Novozymes A/S, Denmark, which folder is hereby included by reference.

### Spectrophotometric Acid Protease (SAPU) Dermination)

This assay is based on a thirty (30) minute proteolytic hydrolysis of a Hammersten Casein Substrate at pH 3.0 and 37° C. Unhydrolyzed substrate is precipitated with trichloroacetic acid and removed by filtration.

Solubilized casein is then measured spectrophotometrically. One Specirophotomevic Acid Protease Unit (SAPU) is that activity which will liberate one (1) micromole of tyrosine per minute under the conditions of the assay.

### Special Apparatus

### Constant Temperature Bath (37+/−0.1° C.)

### Ultraviolet Spectrophotometer (275 nm)

### pH Meter

Stopwatch (Graduated in ⅕ seconds)

### Magnetic Stirrer

### Reagents and Solutions

Glycine-Hydrochloric Acid Buffer (0.05M): Dissolve 3.75 g glycine in approximately 800 ml of distilled water. Using a standardized pH meter, add 1N hydrochloric acid until the buffer is pH 3.0.
Quantitatively transfer to a one (1) liter volumetric flask and dilute with distilled water.
Hydrochloric Acid Solution (1N): Pipette 86.5 ml of concentrated hydrochloric acid into a one (1) liter volumetric flask containing approximately 800 ml of distilled water. Dilute to volume with distilled water.
Hydrochloric Acid Solution (0.1N): Pipette 100 ml of hydrochloric acid solution (1N) into a one (1) liter volumetric flask containing approximately 800 ml. of distilled water. Dilute to volume with distilled water.
Trichloroacetic Acid Solution (1.8% w/v): Dissolve 18.0 g. of Trichloroacetic Acid and 11.45 g anhydrous sodium acetate in approximately 800 ml distilled water. Add 21.0 ml. of glacial acetic acid. Quantitatively transfer to a one (1) liter volumetric flask and bring to volume with distilled water. Prepare a new solution weekly.
Casein: Use Hammersten Casein, available from Nutritional Biochemicals Corp-, 21010 Miles Avenue, Cleveland, Ohio, 44128, or its equivalent.
Casein Substrate (0.7% w/v): With continuous agitation, pipette eight (8) ml, of 1N hydrochloric acid into approximately 500 ml, distilled water. Disperse 7.0 g (moisture-free-basis) Hammersten Casein into this solution. Heat for thirty (30) minutes in a boiling water bath with occasional stirring. Cool solution to room temperature. Dissolve 3.75 g glycine in the solution. Using a standardized pH meter, adjust solution to pH 3.0 by addition of hydrochloric acid solution (0.1N1. Quantitatively transfer to a one (1) liter volumetric flask and dilute to volume with distilled water.

### Enzyme Preparation

Prepare an enzyme solution in 0.05M glycine-HCl buffer so that two (2) ml of the final dilution will give a deltaA of 0.200-0.500. Weigh the enzyme, quantitatively transfer to a glass mortar, and triturate with 0.05M glycine-HCl buffer. Quantitatively transfer to an appropriate volumetric flask and dilute to volume with 0.5M glycine-HCl buffer.

### Assay Procedure

1) Pipette ten (10) ml of casein substrate into a series of 25×150 mm test tubes. Allow at least two (2) tubes for each sample, one (1) for each enzyme blank, and one (1) for a substrate blank. Stopper the tubes and equilibrate them in a 37+/−0.1° C. water bath for fifteen (15) minutes.
2) At zero time, rapidly pipette two (2) ml of an appropriate enzyme dilution into the equilibrated substrate. Start stopwatch at zero time. Mix by swirling, stopper, and replace tubes in bath. It is important that all test tubes be stoppered during incubation.
3) After exactly thirty (30) minutes incubation, add ten (10) ml of TCA solution to each test tube to stop the reaction. Mix by swirling. For safety use a buret or pipetting device.
4) Prepare a substrate blank containing ten (10) ml, casein substrate, two (2) ml 0.05M glycine-HCl buffer and then (10) ml TCA solution.
5) In the following order prepare an enzyme blank containing ten (10) ml casein substrate, ten (10) ml TCA solution, and two (2) ml of the appropriate enzyme dilution.
6) Return all test tubes to the 37° C. water bath for thirty (30) minutes, allowing the precipitated protein to coagulate completely. Transfer the tubas to an ice bath for five (5) minutes.
7) Filter each sample through Whatman No. 42 filter paper. The filtrate must be perfectly clear.
8) Determine the absorbance of each filtrate at 275 nm against the substrate blank. Correct each absorbance by subtracting the absorbance of the respective enzyme blank.

### Calculations

One Spectrophotometric Acid Protease Unit (SAPU) is that activity which will liberate one (1) micromole of tyrosine per minute under the conditions of the assay.

$$SAPU \text{/} g = \frac{( Delta A * I ) 22}{S \times 30 \times W}$$

Where:

DeltaA=Corrected absorbance of enzyme incubation filtrate at 275 nm.

L=Intercept of standard curve,

22=Final volume in mi. of incubation mixture.

S=Slope of standard curve,

30=Incubation time in minutes

W=Weight in grams of enzyme added to incubation mixture in two (2) ml aliquot.

### Standard Curve Determination

Prepare a stock tyrosine solution by dissolving 181.2 mg. L-tyrosine in sixty (60) ml hydrochloric acid solution (0.1 N). Quantitatively transfer to a one (1) liter volumetric flask and bring to volume with distilled water. Prepare dilutions from the stock tyrosine solution as follows:

| Dilution | micromole Tyrosine/ml |
|---|---|
| 5/50 | .10 |
| 10/50 | .20 |
| 15/50 | .30 |
| 20/50 | .40 |
| 25/50 | .50 |

Determine the absorbance of each dilution at 275 nm against a distilled water blank. Plot absorbance versus micromoles tyrosine per millilitre. A straight line must be obtained. Determine the slope and intercept for use in the calculation. A value close to 1.38 should be obtained. The slope and intercept may be calculated by the least square method as follows:

$$Slope = \frac{n \sum ( MA ) - \sum ( M ) \sum ( A )}{n \sum ( {M}^{2} ) - {( \sum M )}^{2}}$$

$$Intercept = n \sum ( {M}^{2} ) - {( \sum M )}^{2}$$

Where:

n=Number of points on the standard curve.

M=Micromoles of tyrosine per ml, for each point on the standard curve

A=Absorbance of sample.

### Sample Calculations

An unknown fungal protease was diluted to one (1) liter with 0.05M glycine-hydrochloric acid buffer (155.6 mg. 1000 mls.). At zero time, two (2) ml was pipetted into ten (10) ml of equilibrated substrate. Under the conditions of the assay The deltaA of the unknown fungal protease filtrate was 0.355. The slope of the standard curve was 1.39 and the intercept was 0.001.

$$SAPU \text{/} g = \frac{( 0.355 - 0.001 ) ( 22 )}{( 1.39 ) ( 30 ) ( 0.1113112 )} = 600$$

### REFERENCES

Weast, Robert C., Ph.D (1959). C.R.C. Standard Mathematical Tables, Twelfth Ed. The Chemical Rubber Co, Cleveland, Ohio.

### EXAMPLE 1

### Addition of Amylase and Protease Prior to Distillation

The objective of this test is to evaluate the effect of alpha-amylase and protease addition prior to distillation.

18-36 liters of commercially available alpha-amylase (LIQUOZYME™ SC 120 AFAU (KNU)/ml from Novozymes, Denmark)) is added to 80,000 gallon (300,000 liters) of fermentation mash containing milled un-gelatinized corn starch, glucoamylase (SPIRIZYME™ PLUS from Novozymes, Denmark) and propagated yeast (FALI yeast from Fleischmann's Yeast, USA) at the beginning of fermentation fill. The beer feed rate is 102-105 gal/min (386-397 liter/min) (mash fill rate is 105-110 gal/min (397-416 liter/min)). Conventionally, alpha-amylase enzyme addition occurs prior to fermentation fill. The temperature conditions comprise 96-98° F. (36-37° C.) with pH 4.2-4.8. As fermentation proceeds toward completion, the pH decreases to 4.0-4.4.

The pH remains at 4.0-4.4 throughout distillation until pH adjustment prior to subsequent fermentation fill. Upon 55-60 hours of fermentation (residence time in fermentor), the fermentation mixture is batch filled into beer well and allowed to cool to 82-85° F. (28-29° C.). The temperature increases to 107-142° F. (42-61° C.) prior to distillation with temperatures comprising 186-188.5° F. (86-87° C.) in the stripper column. Ethanol is removed from the mixture in the stripper column. A solid and water portion of the mixture is further separated by centrifugation into a whole stillage component and further into a thin stillage component. The thin stillage component is mixed with pre-blend waters. The slurry tank is cooled to 102° F. (39° C.) and fed into the fermentation tank, thus completing the circuit. Additionally, commercially available protease (GC106 from Genencor Int. Inc., USA)) is added in the amount 12 liters into the 80,000 gallon (300,000 liters) fermentation mash at the beginning of fermentation fill along with alpha-amylase.

FIG. 1 displays the percentage of glucose after distillation for two fermentations runs (Run #1 and Run #2). The consistently higher glucose after distillation indicates that alpha-amylase (and protease) addition prior to distillation has the potential to dextrinize residual starches as is indicated by the increased level of glucose in FIG. 1.

1-47. (canceled)

48. A process of distilling fermented mash, comprising adding one or more amylases and/or proteases to a fermented mash before distillation or during distillation.

49. The process of claim 48, wherein the distillation is carried out at a temperature in the range between 60-100° C.

50. The process of claim 48, wherein the amylase is an alpha-amylase.

51. The process of claim 50, wherein the alpha-amylase is present in a concentration of from 0.01 to 1 AFAU per liter fermented mash when entering the distillation equipment.

52. The process of claim 48, wherein the protease is present in a concentration of from 0.01 to 1 SAPU per liter fermented mash when entering the distillation equipment.

53. The process of claim 48, wherein the amylase and/or protease is(are) added to the feed stream coming from the fermentation equipment before entering the distillation equipment or introduced directly to the distillation column.

54. The process of claim 48, wherein the fermented mash is fermented whole grains having been subjected to liquefaction and/or saccharification in an SSF or LSF process.

55. The process of claim 48, wherein the fermented mash is fermented dry or wet milled plant material which before fermentation is held at a temperature of 0° C. to 20° C. below the initial gelatinization temperature for a period of 5 minutes to 12 hours, in the presence of an acid alpha-amylase activity, a maltose generating enzyme activity and an alpha-glucosidase activity.

56. The process of claim 48, wherein the fermented mash is fermented dry or wet milled plant material which before fermentation is subject to saccharification, without cooking, with an enzyme composition comprising acid fungal amylase.

57. The process of claim 48, wherein the fermented mash comprises ethanol.

58. A process for production of ethanol, comprising the steps of:
(a) milling plant material,
(b) liquefaction of the milled plant material by acid treatment or treatment with an amylase,
(c) saccharifying using a glucoamylase,
(d) fermenting using a fermenting organism, and
(e) distilling the fermented mash obtained in step (d) in accordance with the process of claim 48.

59. The process of claim 58, wherein the liquefaction, saccharification and fermentation steps are carried out simultaneously (LSF).

60. A process for the production of ethanol, comprising the steps of:
(a) milling plant material,
(b) saccharifying, without cooking, the milled material obtained in step (a) with an enzyme composition comprising acid fungal amylase,
(c) fermenting using a fermenting organism, and
(d) distilling the fermented mash obtained in step (c) in accordance with the process of claim 48.

61. The process of claim 60, wherein the saccharification and fermentation steps are carried out simultaneously (SSF).

62. The process of claim 60, further comprising liquefaction, wherein the liquefaction, saccharification and fermentation steps are carried out simultaneously (LSF).

63. A process of claim 62, comprising the steps of:
(a) milling plant material,
(b) liquefying, saccharifying, and fermenting milled plant material using a fermenting organism, and
(c) distillation of the fermented and saccharified material obtained in step (b) in accordance with the process of claim 48.

64. A process of claim 63 wherein step (b) is carried out without cooking.

65. The process of claim 63, wherein an acid alpha-amylase is present during step (b).
